(19) United States
(12) Patent Application Publication
(10) Pub. No.: US 2020/0111114 A1
(43) Pub. Date: Apr. 9, 2020

(54) WEB-BASED PROMOTIONAL GIVE-AWAY MARKETING SYSTEM

(71) Applicant: Ryan Sinato, Ringoes, NJ (US)

(72) Inventor: Ryan Sinato, Ringoes, NJ (US)

(21) Appl. No.: 16/155,130

(22) Filed: Oct. 9, 2018

(51) Int. Cl. G06Q 30/02; G06Q 50/00; G06F 17/30

(52) U.S. Cl. CPC G06Q 30/0212; G06F 17/30882; G06Q 30/0277; G06Q 50/01

(57) ABSTRACT

A web-based marketing system solicits donations of products and services from affiliated businesses and distributes donated items to interested system members on a random selection basis. The system posts on one or more social media platforms for each donated item and also lists it under the relevant categories on a dedicated website which members can browse. Each social media and webpage listing of the donated item has an affiliate link which enables members to purchase more items from the donor business, thereby promoting the products/services of the affiliated businesses.

### FIELD OF INVENTION

This invention relates to the general field of digital marketing, and more particularly to digital marketing systems which utilize social media.

### BACKGROUND OF THE INVENTION

A long-standing marketing method involves “give-aways” of products and services in order to introduce them to customers and promote follow-up sales to the same customers or to their friends and families. One of the limitations of traditional “give-away” marketing promotions is that they are segregated by brands, so that a customer seeking to participate in a give-away promotion of a particular product or service must visit the websites of each business offering such give-aways. The present invention addresses the unmet need for a centralized digital platform for promotional give-away of products and services.

### SUMMARY OF THE INVENTION

The present invention is a web-based marketing system which solicits donations of products and services from affiliated businesses and distributes donated items to interested system members on a random selection basis. The system posts on one or more social media platforms for each donated item and also lists it under the relevant categories on a dedicated website which members can browse. Each social media and webpage listing of the donated item has an affiliate link which enables members to purchase more items from the donor business, thereby promoting the products/services of the affiliated businesses. Members can tag web pages of businesses they would like to have affiliated with the system and tag social media friends for referrals to donor businesses and/or specific donated items. For larger donations, the system generates a promotional YouTube video about the donor business. The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a block diagram of a web-based marketing system according to one embodiment of the present invention.

### DETAILED DESCRIPTION OF THE PREFERRED EMBODIMENT

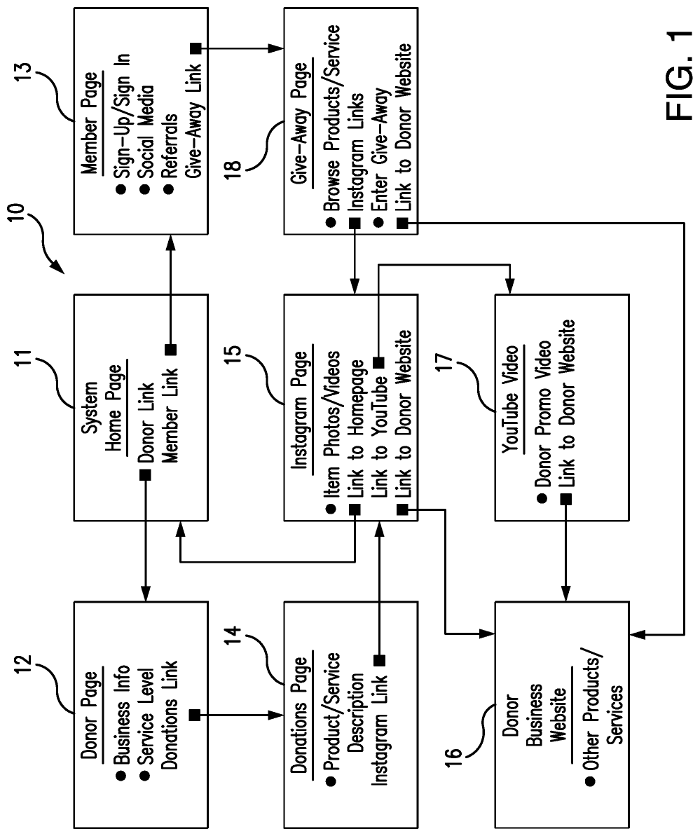

Referring to FIG. 1, a web-based promotional give-away marketing system according to one embodiment of the present invention 10 comprises a System Home Page 11 containing links to a Donor Page 12 and a Member Page 13. Donors are businesses that participate in the marketing system by contributing their products and/or services to be given away, on a random basis, to registered Members who have entered into the give-away.

On the Donor Page 12, the donor enters its business information and selects a service level associated with a service fee. The basic service fee covers a one-cycle advertising campaign for the promotional give-away on at least one social media platform, which in the exemplary embodiment is Instagram. Other participating social media platforms can include Facebook, Twitter and Snap-Chat. A higher premium service fee covers a multi-cycle advertising campaign on the social media platform(s), as well as a promotional YouTube video, which is linked to the social media ads.

The Donor Page 12 contains a link to a Donations Page 14 on which the Donor can donate one or more give-away items by entering descriptions of the products and/or services. The Donations Page 12 will then generate a link to at least one social media page, which in this example is an Instagram Page 15, on which the Donor can post photos and/or videos of the give-away item(s).

In addition to photos and/or videos of the give-away item(s), the Instagram Page 15 (and other participating social media pages) contains links to the System Home Page 11 and the Donor Business Website 16. The link to the System Home Page 11 enables a viewer of the

Instagram Page 15 to follow the link to the Member Page 13, from he/she can enter the give-away for the item(s) shown on the Instagram Page 15. The link to the Donor Business Website 16 enables the viewer to shop for products and/or services related to those shown on the Instagram Page 15. Where the Donor has signed up for the premium service level 12, the Instagram Page 15 will also contain a link to the YouTube Video 17 that the Donor has posted promoting its products and/or services. From the YouTube Video page 17, there is also a link to the Donor Business Website 16, further enhancing the promotional benefits of the YouTube Video 17.

People become eligible for random-selection for the give-aways by becoming Members through the Member link on the System Home Page 11. On the Member Page 13, a person becomes a Member by signing up and creating an account by providing his/her e-mail, social media handles and friend referrals. Once registered in the system, the Member can follow a link from the Member Page 13 to a Give-Away Page 18, where the Member can browse products and/or services that have been donated and enter for the give-away of specific items. The number of give-aways in which a Member can participate will depend upon the number of friend referrals the Member has provided.

The Give-Away Page 18 also has links to the social media postings for each give-away item—in this example the Instagram Page 15—as well as links to the Donor Business Websites 16. Using an App downloadable from the System Homepage 11, a Member can tag items on Donor and non-Donor websites that the Member would like to have included in the system's give-away products/services.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A web-based marketing system based on promotional give-aways of products and services, the system comprising:
a system website comprising a system home page containing links to a donor page and a member page;
wherein the donor page, or one or more system web pages of the system website linked to the donor page, is configured to register a donor and accept from the donor a service fee and at least one donated item to be offered by the system among the promotional give-aways;
wherein the member page, or one or more system web pages of the system website linked to the member page, is configured to register a member and enter the member as a potential recipient of one or more of the promotional give-aways;
wherein the system generates social media advertisements for each of the promotional give-aways on at least one participating social media platform; and
wherein the system periodically selects one of the potential recipients to receive gratuitously one of the promotional give-aways.

2. The system according to claim 1, wherein each of the social media advertisements contains a link to the system homepage, through which viewers of the social media advertisements can register among the members or the donors of the system so as to participate in the promotional give-aways.

3. The system according to claim 2, wherein the member page, or one or more system webpages linked to the member page, contains links to each of the social media advertisements.

4. The system according to claim 3, wherein the donor page, or one or more system webpages linked to the donor page, contains links to each of the social media advertisements for each of the donated items contributed to the system by the donor.

5. The system according to claim 4, wherein one of the participating social media platforms is Instagram.

6. The system according to claim 5, wherein, for an extra service fee, the donor posts a promotional video on YouTube, and wherein the system generates links from each of the social media advertisements to the promotional video on YouTube.

7. The system according to claim 6, wherein on the member page, or on one or more of the system webpages linked to the member page, the member can initiate friend referrals of social media friends to the system website, and wherein the member participates in a number of promotional give-aways determined by a number of friend referrals made.

8. The system according to claim 7, wherein each of the social media advertisements contains a link to a business website of the donor of the donated item advertised.

9. The system according to claim 8, wherein the member page, or one or more of the system webpages linked to the member page, contains links to the business website of each donor of one or more of the promotional give-aways.

10. The system according to claim 9, wherein the system website contains one or more links to a downloadable system application software, whereby the member can tag third-party websites as potential donors in the system.

11. The system according to claim 10, wherein the system application software enables the member to tag specific items on the third-party websites as potential promotional give-aways in the system.
